(19) United States
(12) Patent Application Publication
(10) Pub. No.: US 2019/0166210 A1
(43) Pub. Date: May 30, 2019

(54) METHOD FOR ACCESSING A CONTENT HOSTED ON A SERVER SELECTED AS A FUNCTION OF THE LOCATION OF THE USER TERMINAL

(71) Applicant: ORANGE, Paris (FR)

(72) Inventor: Ivan Froger, Lannion (FR)

(21) Appl. No.: 16/300,775

(22) PCT Filed: May 4, 2017
(86) PCT No.: PCT/FR2017/051082

§ 371 Date: Nov. 12, 2018

(30) Foreign Application Priority Data
May 10, 2016 (FR) 1654177

(51) Int. Cl. H04L 29/08; H04L 29/12; H04W 76/11

(52) U.S. Cl. CPC H04L 67/18; H04L 67/1021; H04W 76/11; H04L 67/02; H04L 61/2007; H04L 61/1511

(57) ABSTRACT

A method for accessing a content located in a telecommunications network implemented by a user terminal connected to an equipment item of at least one access network of the telecommunications network. The method includes: receiving at least one message originating from the equipment item, containing an information item relating to the location of the user terminal; generating a request for access to a content containing a location indication obtained on the basis of the information item extracted from the message; dispatching the generated access request to a server able to select a contents server; and receiving an address of the selected contents server.

### FIELD OF THE INVENTION

The invention lies in the field of communications networks and relates more particularly to a technique for accessing a content hosted on a server which is selected as a function of the location of the user terminal.

### PRIOR ART

An upgrade in telecommunications networks consists in contriving matters so that the contents servers are as close as possible to the terminals wishing to access these servers. This is explained for various reasons:
On the one hand the contents, composed ever more of video, require ever more bandwidth and therefore ever more transmission capacity;
On the other hand, in particular as regards mobile infrastructures, operators are seeking to reduce the latency of networks as far as possible and one of the means of action for reducing this latency is to bring contents servers closer to user terminals;
Finally, and without the reasons mentioned to explain this upgrade consisting in bringing contents servers closer to users being exhaustive, the bandwidth used to convey the streams represent an investment and management cost.

These reasons explain in particular the development of infrastructure and of cache servers in networks, that are called CDNs (Content Delivery Networks). Access to contents via for example the HTTP (HyperText Transfer Protocol) protocol is usually implemented via CDN servers managed by the operator of the communication network or by an external entity. Bringing terminals closer to the infrastructure of CDN servers is a first element of response but it remains to select the CDN server which is best positioned in relation to the user terminal when several CDN servers host or might host the same content.

At the same time, communications networks themselves are being upgraded with the introduction of virtualized functions and architectures of MEC (Mobile Edge Computing) type or based on Fog computing (technique which consists in hosting the applications at the network periphery, therefore as close as possible to the users), these two types of architecture having in common that they distribute as near as possible to the users the software applications of which the user makes use and the contents. This relates a priori to a variety of functions such as those concerned with caching, with security or with roaming. By bringing functions and contents closer to user terminals, these types of architecture differ from so-called “cloud” architectures, characterized by centralized functions and services, generally remote from the user terminals.

These new architectures (MEC, FOG . . . ) break in particular with the mobile network architectures deployed today. These mobile network architectures are characterized by contents servers positioned beyond—that is to say upstream in the downgoing sense toward the user—the GGSN (Gateway GPRS Support Node) or PDN-GW (Packet Data Network Gateway) gateways which are the point of entry of the mobile network and which are therefore deployed between the packet networks where the servers and the mobile access networks are situated. These gateways are themselves quite centralized, and the contents servers are therefore fairly far from the users. Options for upgrading these mobile architectures, in particular within the framework of fourth and then fifth generation networks, rely on a wider distribution of the mobile gateways and therefore of the functions supported by these gateways.

Furthermore, it should be noted that fixed architectures and mobile architectures are fairly specific and today not very convergent, entailing functions and services related to addressing, to naming, to contents servers. Thus, a CDN server is usually specific to fixed accesses or to mobile accesses but it is very infrequent for one and the same CDN server to be reachable by a mobile user and a fixed user who are geographically close. However, operators, with the aim of converging their offerings, are further inclined to contrive matters so that any type of content is accessible from any type of terminal connected to any type of access and also to rationalize their architectures by deploying common functions and services for the various types of access.

In current techniques, the selection of a contents server, for example an HTTP server of a CDN architecture, from among a set of servers deployed at various places in the network in order to bring content closer to users, is carried out by way of a DNS (Domain Name Server) server and/or redirection of an HTTP request. Thus, it is possible to select the server as a function of the DNS architecture. More precisely, the terminal wishing to access a content makes a DNS request for this content and addresses itself to its primary DNS resolver, the latter having the role of thereafter contacting the authority DNS server having the information relating to the location of the content sought, directly or else by way of other DNS servers. The objective being to give the terminal the address of the content server closest to the terminal, the techniques used today to meet this need rely on taking into account the address of the primary DNS server invoked by the terminal to access a content. This information is in certain cases insufficient or else not precise enough in particular if the primary DNS server is centralized or else if the terminal uses a virtual private network to access the contents, in which case its primary DNS server is situated at too remote a site relative to what is desirable. In these cases the address of the primary DNS server gives inexact or insufficient information on the location of the user terminal.

A possibility for solving this problem is to densify the DNS architecture and to distribute the primary DNS servers more widely so that the information on the primary DNS server is correlated with better location of the terminal, which from an architectural point of view and for network administration and cost reasons, turns out to be a hardly relevant option.

Another alternative, proposed in the current techniques, consists in using HTTP redirection and in contriving matters so that the selected content server is associated with the IP address allotted to the terminal once the HTTP request reaches a centralized server. The role of this centralized server is, on the basis of the IP address of the terminal invoking the content, to transmit an “HTTP redirection” message to the terminal so that it accesses the desired content by contacting the local server, close to the terminal, which was indicated to it by the centralized server in the HTTP redirection message. This scheme is not however appropriate for mobile networks where the IP address allocated to the terminal does not have any significance in terms of geographical location, nor to private networks where the address allocated to the terminal generally arises from a centralized “pool” of addresses and does not therefore have any significance in terms of location, thus entailing that the content server indicated will not necessarily be geographically close to the terminal.

Another option consists in including the sub-network information item contained in the IP address allotted to the client in the DNS requests, in accordance with what is specified in the document draft-ietf-dnsop-edns-client-subnet-06 (15 Dec. 2015). Thus, the sub-network information item contained in the IP address of the terminal can be used to select the contents server. This option does not deal with the contents server selection problem since in mobile networks or in virtual private networks, this sub-network information item does not suffice to identify a content server close to the terminal. The object of the present invention is to remedy these drawbacks.

### DISCLOSURE OF THE INVENTION

The invention improves the situation with a method of access to a content located in a telecommunications network, implemented by a user terminal connected to a device of at least one access network of the telecommunications network, comprising the following steps:
A step of receiving at least one message originating from the device, comprising an information item relating to the location of said user terminal;

A step of generating a request for access to a content comprising a location indication obtained on the basis of the information item extracted from the message;

A step of dispatching said access request generated to a server able to select a contents server;

A step of receiving an address of the selected contents server.

According to the earlier techniques, the selection of a contents server as close as possible to the user is usually carried out on the basis of information based on IP addressing. The IP address of the client of the terminal of the client or of the DNS resolver is usually taken into account for the selection of a contents server which is geographically close to the terminal. However, the IP address, used equally to identify and to locate a terminal, does not always actually fulfill the role of locator in particular when the IP addresses are not allocated according to a geographical organization as is the case for most mobile operators, or indeed when the clients' terminals are connected via proxies or else tunnels. By virtue of the invention, knowing that location information items are transmitted to the terminals by access networks, for example of cellular type or of Wi-Fi type, the objective consists in basing oneself on this information item to select the most suitable contents server. The selected contents server must be close from a geographical point of view but also from a topological point of view so as to minimize access costs, limit latency times and improve user quality of experience. It is conceivable for the terminal to receive several location information items dispatched by devices of several access networks to which the terminal is connected. In order to be able to use this or these information item(s), it is necessary initially that the terminal, once it has received a location information item from a device of at least one access network via the module for connection to this access network, transfers it to the module for generating the requests for contents. Indeed, this location information item, in the earlier techniques, is usually used solely for roaming services characterizing mobile architectures. In this invention, a location indication based on at least one received location information item is created and used for the selection of a server and must therefore be transmitted to another module of the terminal, in this instance the module in charge of the creation of the requests for access to a content, these requests being able to be HTTP requests or DNS requests or any other type of protocol used during exchanges of contents between a terminal and a server. Thus the terminal, when it establishes an HTTP request or else a DNS request for a given service, is able to add a location indication, based on at least one location information item, to this request and thus allow the utilization of this information item. Once this information item has been added to the request, the terminal transmits this request including the location indication, to the selection server, usually a DNS or HTTP server. Thus the selection server has at its disposal an information element in respect of location of the terminal which is reliable and which can be utilized to select a contents server which is relevant in relation to the location of the terminal.

According to a particular characteristic, the request for access to a content of the method of access is a request of HTTP type.

The client uses a terminal connected to an access network and opens a browser to access contents of HTTP type. According to the invention, the terminal has been informed of its location, via an information item transmitted by at least one access network, and constructs an HTTP request by including the location indication based on a location information item obtained from at least one access network.

In the case of the HTTP protocol, the location information item might be transmitted in the HTTP GET message dispatched by the terminal to invoke the contents server.

According to the implementation of the terminal, it may entail a default manner of operation and in this case, all the HTTP requests integrate this location information item, independently of the fact that the latter is or is not actually taken into account by the HTTP server invoked. Another option consists in a pre-configuration of the terminal consisting in including this location information item only for a limited list of contents for which this information item is actually taken into account for the selection of the most suitable contents server. This pre-configuration for a dynamic implementation could consist of an invoking on the part of the server according to the requested content, for example for a content provider or a specific domain.

This location indication transmitted in the HTTP request will be able in particular to be used for the HTTP redirections, where a contents server returns a redirection information item to the terminal for diverse reasons, in particular because a content is available at another address or else so as to distribute the load over several servers. Here, the location indication might be used to determine a new contents server and the selection server will be able to dispatch the HTTP redirection message to the user terminal via an “HTTP redirect” message. The user terminal, on receipt of this message, is able to access the desired content by invoking the contents server whose address was dispatched by the selection server in the “HTTP redirect” message.

According to another particular characteristic, the request for access to a content of the method of access is a request of DNS type.

The location indication will advantageously be able to be used to enrich the DNS requests dispatched by the terminal and relayed by the intermediate DNS servers up to the final DNS server or authority DNS server, the latter providing the IP address of the server to which the terminal must connect in order to access the content sought. The location indication transmitted in the DNS request issued by the terminal affords the DNS server invoked a means of being able to associate a contents server as a function of the location indication transmitted in the request. This indication, in a first option, might be transmitted in a systematic manner with all the DNS requests issued by the terminal independently of the fact that this information item is or is not supported and taken into account by the DNS servers. An alternative consists in inserting this location indication only into certain DNS requests, for example for specific contents, because the servers involved in the resolution of the name are compatible and can actually exploit the indication inserted by a user terminal.

On the basis of the location indication, the DNS server in charge of the resolution of the domain name relating to the content invoked by the terminal returns the address of the contents server that the terminal must reach in order to actually access the content.

According to another particular characteristic, the method of access is implemented on an access network of cellular type and the information item relating to location is based on a parameter of “Tracking Area” type.

In the case where the terminal is connected to a, for example, fourth generation cellular network, that is to say to an LTE (Long Term Evolution) network, the location information item received from the LTE network consists of parameters forming the TAI (Tracking Area Identity). This information item can advantageously be used to determine a geographical location of the terminal. In an LTE network, the terminal is informed during its attachment of the zone identified as Tracking Area to which it belongs, this zone being able to cover several cells or several devices of eNodeB type according to the configuring of the network by the operator. In order to limit the number of Tracking Area updates dispatched by the terminal to the MME (Mobility Management Entity) of the LTE network when the terminal is roaming, the terminal is generally informed of a list of “Tracking Areas” by virtue of an information item of TAL (Tracking Area List) type. The terminal will be able by choice to use the TAI information item, or one of its components such as the TAC (Tracking Area Code), or else the TAL information item to generate a location indication in its content access request messages. For example, the terminal will be able to insert into its HTTP, DNS or other type requests, the TAL list received from the LTE network or else only some of the Tracking Areas present in the list, or indeed a TAL list identifier if this location indication can be utilized by the selection server. This information item based on the Tracking Areas is forthwith present and used in mobile networks in particular for location purposes for roaming services. It will therefore be able advantageously to be utilized for other purposes such as the selection of a suitable contents server in relation to the location of the terminal.

According to another particular characteristic, the method of access is implemented on an access network of Wi-Fi type and the information item relating to location is based on a parameter of SSID (Service Set Identifier) type.

In the case where the terminal is connected to a WLAN network, for example a Wi-Fi network, the location information item received from this Wi-Fi network is the SSID information item. This information item can advantageously be used to determine a geographical location of the terminal on condition that the various SSIDs to which the terminals can potentially connect are referenced and may actually be associated a location which is sufficiently precise to actually select a contents server close to the user connected to the Wi-Fi network in question. In the case where the Wi-Fi network is a network administered by the operator or else by an entity in conjunction with the operator managing the selection server, the various SSIDs managed by the operator or the entity can serve to select a contents server in proximity to the user terminal. In the case where a terminal is connected to several Wi-Fi networks simultaneously, the various information items of SSID type received from the various Wi-Fi networks will advantageously be able to make it possible to generate a location indication based on these various SSID information items. The case of usage described presents the advantage of being applicable to non-cellular Wi-Fi terminals. Moreover they allow better performance perceived by the user and better use of the network resources in cases of inter-access roaming in the course of a data session.

The various aspects of the method of access which have just been described can be implemented independently of one another or in combination with one another.

According to a second aspect, the invention relates to a method of selection implemented by a selection server comprising the following steps:
Reception of a message requesting access to a content originating from a user terminal comprising an indication of location of said user terminal;
Selection of a contents server as a function of the location indication;
Dispatching of a message comprising an address of said contents server to the user terminal.

On receipt of a received request for access to a contents server, the selection server, if it is the server in charge of the actual selection of the contents service via which the terminal will be able to access the content, selects a server by taking into account the location indication present in the request. In the case where this entails a server accessible through an HTTP request, an HTTP server or a CDN server, the latter will be able to use a table making it possible to match a location indication with a corresponding contents server, making it possible ultimately to inform the user of the IP address of a server in proximity, for example by dispatching an HTTP redirection message comprising the IP address of the selected content server. In the same manner, if the resolution server is a DNS server, the latter will use the location information item to select for example an HTTP server, a CDN server or indeed an FTP server, close to the user terminal and to indicate the IP address of this server to the terminal that made the access request.

The infrastructures of CDN type and of DNS type usually being deployed in a hierarchical manner, it is very frequent for a request for access to a content to be routed gradually by intermediate servers up to the final server, actually in charge of selecting the contents server and of so informing the user terminal. These intermediate selection servers do not themselves select certain contents servers but must not filter, modify or delete the indication relating to location when they receive and then retransmit the request for a content to another selection server. They must therefore, when they receive a request for access to a content including a location indication, ensure that this request is retransmitted with the location indication to the following selection server.

According to a particular characteristic, the method of selection furthermore comprises a step of consulting a lookup table of correspondence between location indications relating to at least two types of access networks.

If the user terminal is connected to a Wi-Fi network and to a cellular network, it is liable to receive at one and the same time a location information item of Tracking Area type and an information item of SSID type, in which case the terminal can generate a location indication based on these two location information items or else generate two location indications, based on the two respective information items. In particular, a terminal will simultaneously be able to be connected to at least two access networks simultaneously and receive several location information items simultaneously, on the basis of which it will generate one or more location indications. It should be noted that it is not necessary for it to be connected to the cellular network in order to have two location information items. In the case where the terminal has capabilities for connection to a cellular network, with an active SIM (Subscriber Identity Module) card, and when it has attached itself previously to a cellular network, it has in memory an information item of TA type even if it is not connected to the cellular network whilst it connects to the Wi-Fi network.

If the terminal is liable to connect to a Wi-Fi network or to an LTE network, it is also possible to envisage the automatic construction of a lookup table of correspondence between the SSID information items and the TA (Tracking Area) related information items, and which is interfaced with the content selector. In a first mode, any terminal connected to a Wi-Fi network would dispatch its Wi-Fi access SSID identifier in its content request. The content server selection would be done thereafter on the basis of the SSID-TA correspondence which could be formulated on the basis of the TA and SSID information items transmitted by the terminals with the capability to connect to Wi-Fi and cellular networks. Another possible mode of use of this correspondence would be an upgrade of the Wi-Fi accesses which would imply that these parameters TAI and TAL, which today are broadcasted exclusively on cellular networks, are broadcast to the terminals by the Wi-Fi access points. Thus the location identifier would be identical between cellular networks and Wi-Fi networks, for simpler server selection management and a homogenization between Wi-Fi and LTE architectures.

The creation and the updating of the lookup table can be effected in various ways. In particular, it can be envisaged that the operator or the lookup table provider produces and updates a lookup table on the basis of a mapping of the geographical coordinates of the devices providing the location information items, for example SSID and TAI. This table will also be able advantageously to benefit from the information items arising from the cellular radio coverage maps. The lookup table could also be created and updated by a learning scheme, where the location indications gathered from the terminals and supplemented with other information items such as the identifier of the terminal, the session identifier and its GPS coordinates would be recorded in order to feed the lookup table. These proposed schemes are not exclusive and could also be used jointly. The present invention also envisages a user terminal able to access a content located in a telecommunications network, connected to a device of at least one access network of the telecommunications network, the terminal comprising the following modules:
A module able to process a received message originating from the access device comprising an information item relating to the location of said user terminal;
A generator of a request for access to a content comprising a location indication obtained on the basis of the information item extracted from the message;
A module able to process a message of issuing of the access request generated to a server able to select a contents server;
A module able to process a message comprising an address of the selected contents server.

The present invention also envisages a selection server comprising the following modules:
A receiver of a message requesting access to a content originating from a user terminal comprising an indication of location of said user terminal;
A selection module for selecting a contents server as a function of the location indication.

According to a particular characteristic, the selection server furthermore comprises a lookup table of correspondence between location indications relating to at least two types of access networks.

The invention also relates to a system for accessing a content comprising at least one selection server and at least one terminal.

In another embodiment, the invention relates to one or more computer programs comprising instructions for the implementation of at least one method such as described hereinabove, when this or these programs are executed by a processor.

This program can use any programming language, and be in the form of source code, object code, or of code intermediate between source code and object code, such as in a partially compiled form, or in any other desirable form.

The invention also envisages an information medium readable by a computer, and comprising instructions of a computer program such as mentioned hereinabove.

The information medium can be any entity or apparatus capable of storing the program. For example, the medium can comprise a storage means, such as a ROM, for example a CD ROM or a microelectronic circuit ROM, or else a magnetic recording means, for example a diskette (floppy disk) or a hard disk.

Moreover, the information medium can be a transmissible medium such as an electrical or optical signal, which can be conveyed via an electrical or optical cable, by radio or by other means. The program according to the invention can be in particular downloaded from a network of Internet type.

Alternatively, the information medium can be an integrated circuit in which the program is incorporated, the circuit being adapted to execute or to be used in the execution of the methods in question.

### LIST OF FIGURES

Other characteristics and advantages of the invention will be apparent on reading in the description detailed hereinafter particular embodiments, given by way of nonlimiting examples, and the appended figures in which:

FIG. 1 illustrates in a schematic manner a system for accessing a content involving a user terminal connected to at least one access network and a selection server. The selection server can be a DNS server, an HTTP server or any other type of server.

FIG. 2 illustrates the various steps of the method of access according to one embodiment of the invention where the selection server is a DNS server.

FIG. 3 illustrates the various steps of the method of access according to another embodiment of the invention where the selection server is an HTTP server.

FIG. 4 illustrates the various steps of the method of selection according to another embodiment of the invention where the terminal is successively connected to two different access networks.

FIG. 5 illustrates the structure of a user terminal implementing the various steps of the method of access according to a particular embodiment.

FIG. 6 illustrates the structure of a content selection server implementing the various steps of the method of selection according to a particular embodiment.

### DETAILED DESCRIPTION OF AT LEAST ONE EMBODIMENT OF THE INVENTION

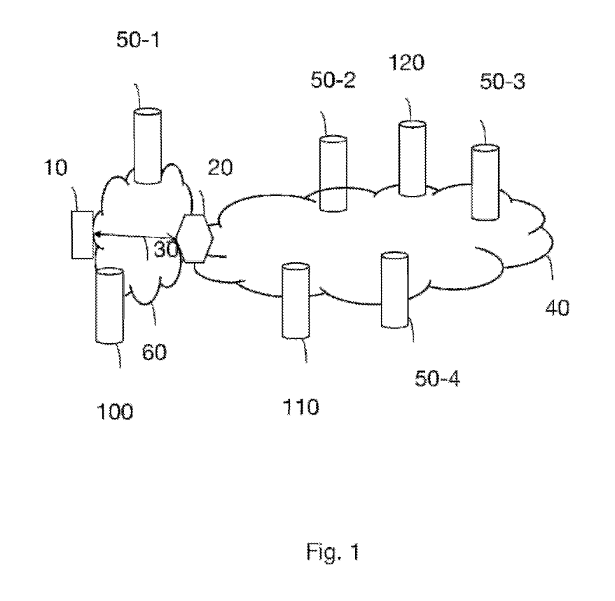

FIG. 1 is referred to firstly, which illustrates in a schematic manner a system for accessing a content involving a user terminal connected to at least one access network, as well as a selection server.

In this figure is represented a user terminal 10 which is connected to an access device 20. The user terminal 10 can equally well be a mobile terminal or a computer or a domestic gateway or any other device capable of communicating with the access device 20 by using a wired or radio connection 30. In this figure are also represented contents servers 50-1, 50-2, 50-3, 50-4 deployed at different locations of the communications network composed of the access infrastructure 60 and of the transport infrastructure 40. These access 60 and transport 40 infrastructures may either be networks of radio or wired type. In this FIG. 1 is furthermore presented a selection server 110 intervening in the method of selecting a contents server from among those deployed 50-1, 50-2, 50-3, 50-4 within the communications network. In this FIG. 1 are furthermore represented DNS servers. One of the servers named primary DNS server 100 to which the terminal 10 connects by default for a name resolution and another so-called global 120, here considered to be the authority server ensuring the actual resolution of the name of the contents server which the terminal 10 must access. This FIG. 1 illustrates a particular embodiment and in other embodiments, more DNS servers, more selection servers and more contents servers could in particular be taken into account. Moreover, the terminal could be connected simultaneously to several access devices optionally using different access technologies.

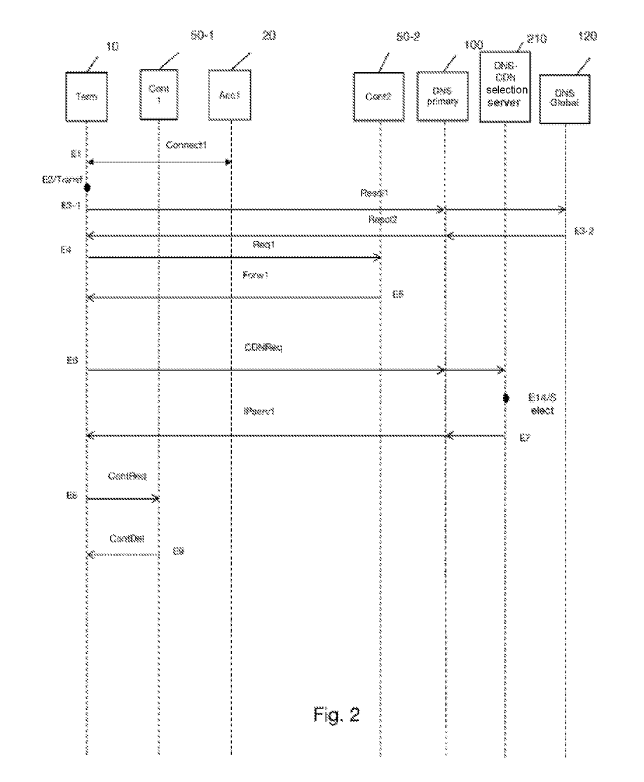

Reference is now made to FIG. 2 which illustrates the various steps of the method of access according to one embodiment of the invention. In this embodiment, the selection server 210 is a DNS server which informs the terminal 10 about the contents server 50-1 to be reached.

During a step E1 the user terminal 10 connects to an access device 20. This access device 20 according to the embodiments can be an access gateway to a cellular network of LTE, UMTS type or of any other mobile infrastructure for example a PDN-GW (Packet Data Network Gateway), a device for access to a Wi-Fi network such as an access point, a device for access to a fixed network such as a BRAS (Broadband Remote Access Server) or a BNG (Broadband Network Gateway). During this step E1 of connecting to an access device 20, the terminal 10 is configured with an IP address and can also obtain information items, including the IP address of the primary DNS server 100 to be contacted in order to access the name resolution service.

During this step of connecting to the access device 20, the terminal 10 furthermore receives an information item in respect of its current location in relation to the topology of the network. If this entails a connection to an LTE network, this information item will be the Tracking Area (TA) information item dispatched by a device of the mobile network allowing the location of the terminal in such a network. If it entails a UMTS or GPRS network, the location information item will be of Location Area (LA) and/or Routing Area (RA) type. Any location information item or indeed network identifier information item obtained by the user terminal of the access network might be exploited for the implementation of the method of access. For the sake of simplification, the connection step E1 does not exhibit the various successive phases that may occur when a terminal 10 connects to an access device 20. In particular if this entails an LTE access network, this connection step E1 can be decomposed into phases of radio attachment, into network access control phases and into a network connection phase involving various devices of the LTE architecture, including the eNodeB devices, the S-GWs (Serving Gateways), the PDN-GWs (Packet Data Network Gateways), the MMEs (Mobility Management Entities), the HSS (Home Subscriber Server) server or indeed PCRF (Policy and Charging Rules Function) and AAA (Authentication Authorization Accounting) servers. The Tracking Area information item will in particular be transmitted by the MME in the LTE architecture by virtue of messages of the NAS (Non Access Stratum) layer forming part of the connection step E1 described here. In an identical manner, the connection of the terminal 10 to a Wi-Fi, ADSL or optical access device is reduced to the connection step E1 but groups together several exchanges between the terminal and the devices of the access network. This invention, whatever the embodiment, considers that an information item relating to its location is dispatched to the terminal 10 by an access device 20 in the course of the connection step E1.

During a step E2, the location information item transmitted by the access device in the course of step E1 is transmitted to the terminal 10 in such a way that it generates requests for access to a content comprising a location indication based on the location information item received from an access device 20. One embodiment consists in the terminal generating an access request containing the location information item received during step E1. Another embodiment consists in determining a location indication based on one or more location information items received. If the terminal 10 is connected simultaneously to several different access devices, for example networks of Wi-Fi and LTE type, it will receive several location information items originating from the various access devices of the networks. In this case, it will be able to generate a location indication based on these location information items, by selecting one of these information items to generate the location indication, or by generating an indication based on the various location information items received from the access devices according to the embodiment adopted.

During a step E3-1 the terminal contacts its primary DNS server 100 which itself invokes the authority DNS server 120 for the name of the host of the contents server 50-2 and which can therefore actually provide the IP address of this server exhibiting the content which the terminal 10 wishes to access. In the course of step E3-2, the authority DNS server 120 returns via the primary DNS server 100 a response to the invocation transmitted during step E3-1.

During a step E4, the terminal 10 dispatches a request for access to a content server 50-2. In this embodiment, the access request is an HTTP request to an HTTP server 50-2 whose terminal will have obtained the address by DHCP configuration or during the exchanges of steps E3-1 and E3-2. The access request issued during step E4 comprises the location indication generated by the terminal 10 during step E2 on the basis of the at least one location information item received. During step E5, the HTTP server 50-2 returns in a response message an information item about the CDN server to be contacted—for example in the form of a URL (Universal Resource Locator)—so that the terminal 10 can actually access the requested content.

In this embodiment, the selection server is a DNS server. This server ensures the resolution of the name of the CDN server that it will have selected to follow up the request dispatched by the terminal 10 during step 4.

On the basis of this information item about the CDN server to be contacted, the terminal 10 dispatches during a step E6 a DNS request to the authority DNS server 210 of the CDN server indicated in the response message dispatched during step E5. This DNS request will optionally be able to be dispatched via the primary DNS server 100 of the terminal 10 and comprises the location indication generated by the terminal 10. On receipt of the DNS request, the server 210 selects, during a step E14, a contents server 50-1 close to the terminal 10 as a function of the location indication. During step E7, the DNS server 210 returns to the terminal 10 the IP address of the contents server 50-1 that the terminal must reach in order to access the content. The DNS server 210 having used the location indication transmitted in the DNS request issued during step E6 selects the contents server 50-1, the latter being from a geographical and/or topological point of view closest to the terminal 10. During a step E8, the terminal 10 invokes the content server 50-1 by dispatching an HTTP access request. During a step E9, the server 50-1 transmits in response the content invoked via an HTTP request for content delivery destined for the terminal 10.

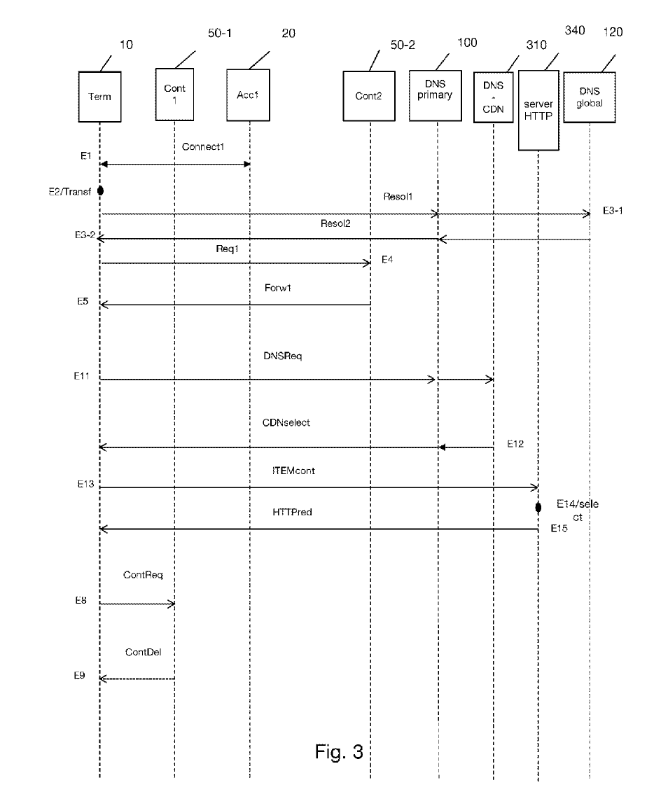

Reference is now made to FIG. 3 which illustrates the various steps of the method of selection according to another embodiment of the invention. In this embodiment, the selection server 340 is an HTTP server which informs the terminal about the contents server 50-1 to be reached via a redirection HTTP message.

Steps E1 to E5 are strictly identical to those described in respect of FIG. 2.

During a step E11 the terminal 10 invokes the DNS server 310 of the CDN server whose name it received in the message issued during step E5 by the contents server 50-2. During this step E11, the location indication is not integrated into the DNS request dispatched to the DNS server 310. This indication, if it is integrated into the DNS request for example for reasons of ease of implementation will not be interpreted by the DNS server 310 and the latter does not determine any suitable contents server. This embodiment differs from the embodiment described in FIG. 2 since the DNS server 310 does not ensure the selection server function and supports only the conventional functions of a DNS server. In response to the DNS request dispatched by the terminal 10 via its local DNS server 100, the DNS server 310 ensuring the resolution of the name of the server 340 returns the IP address of the server 340 to the terminal 10 in a message during a step E12. This message may optionally be issued by the primary DNS server 100 by virtue of a caching mechanism. In this case the message of step E11 did not need to be relayed to the server 310 by the server 100.

The terminal 10, on receipt of the DNS message indicating the IP address of the server 340 to be contacted in order to access the content, dispatches a message requesting access of HTTP type to the IP address of the selection server 340 during a step E13. This HTTP access request includes the location indication. On receipt of the access request, the server 340 selects, during a step E14, a contents server 50-1 close to the terminal 10 as a function of the location indication. During a step E15, the server 340 dispatches a message of HTTP redirection type comprising a URL indicating to the terminal 10 the contents server 50-1 from which the terminal 10 can access the desired content.

A step of DNS resolution of this URL is necessary (between steps E15 and E8) but is not presented here as a step for reasons of ease of reading.
Steps E8 and E9 of FIG. 3, following on from step E15 described previously, are identical to steps E8 and E9 of FIG. 2.

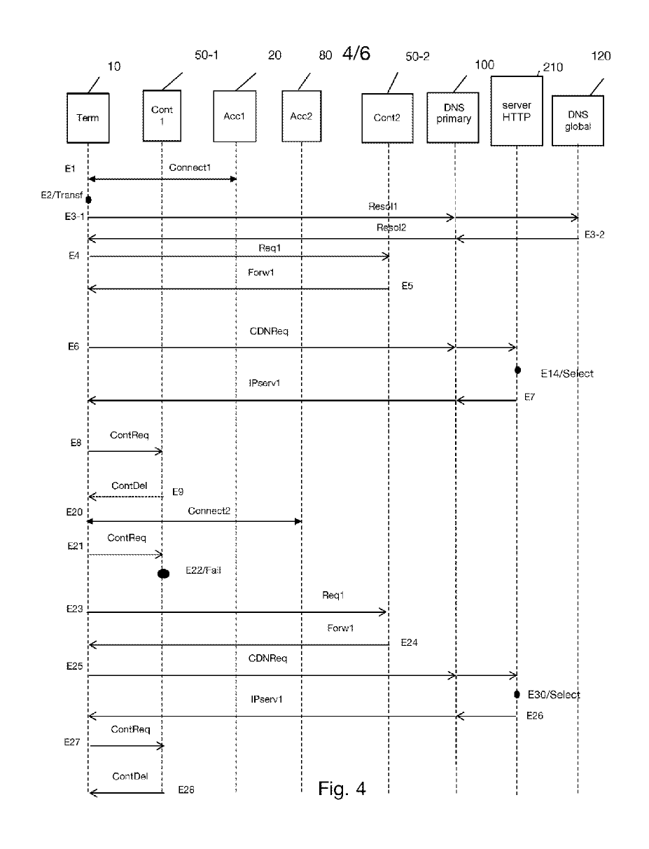

Reference is now made to FIG. 4 which illustrates the various steps of the method of selection according to another embodiment of the invention, in which the user terminal 10 connects successively to two different access networks.

In this embodiment, the first steps from step E1 up to step E9 of FIG. 4, including step E14, are identical to the corresponding steps of FIG. 2 and are therefore not described again. In the embodiment described in FIG. 4, once the terminal has accessed the content hosted on the contents server 50-1, the terminal 10 connects to another access device 80 and is no longer connected to the access device 20 to which it was connected up till then to access the content. The terminal 10 has not necessarily shifted and may be situated geographically in the same place but it is connected to another access device. Various reasons may explain this connection to another access device. The access device 20 may be unavailable, an operator policy may force a connection to a given network, or else the configuration of the terminal 10 may favor a connection to the access device 80 relative to the access device 20, and this may be the case in certain configuration options if the access device 80 is a Wi-Fi gateway whilst the access device 20 is an access gateway to an LTE network. In the case where the two access devices provide access to networks of different technology, it is very probable that on the one hand the IP address allocated to the terminal 10 may change when the latter is connected successively to two different access networks, and on the other hand it is possible that the CDN servers may not be the same. The consequence of this change of connection of the terminal 10 also gives rise to a prohibition of access initially of the terminal 10 to the content hosted on the server 50-1 if the content server 50-1 performs an access control based on the IP address of the terminal 10. The latter can no longer access the contents of the server 50-1 subsequent to its connection to the access device 80 and the content access request dispatched during step 21 gets refused and a break in connection between the terminal 10 and the content server 50-1 occurs during step E22. In the absence of any response from the contents server 50-1 or else if the contents server returns a message prohibiting access to the terminal 10, the terminal 10 invokes via a request for access to a content the default contents server during a step E23 after intervention of the user or not as the case may be, with the aim of relaunching the application. The IP address of this default content server, in the example the contents server 50-2, might be obtained after a new invocation of the global DNS server 120, or else it might be placed in memory by the terminal 10 or by the primary DNS 100 during the DNS invocations and responses of the respective steps E3-1 and E3-2.

During step E24, the contents server 50-2 returns the information item about the CDN server to the terminal 10 so that the latter can access the desired content.

By virtue of this information item which will be able to consist of a URL making it possible to access the CDN server having the content at its disposal, in accordance with what takes place during step E5, the terminal 10 invokes the selection server 210 which in this embodiment is the authority DNS server of the CDN server. During step E25, in a similar manner to step 6, the terminal 10 dispatches a DNS request comprising the location indication arising from the location information item dispatched by the access device 80 when the terminal 10 has connected thereto, to the authority DNS server 210 of the CDN server. This DNS server 210, on the basis of the location indication, selects the contents server 50-1 in proximity to the terminal during step E30 and dispatches the IP address of this server during step E26.

In order to select a contents server 50-1 which is close to the user terminal independently of the access network to which this terminal connects, the DNS server 210 can use a lookup table of correspondence between location indications of various access networks. For example, in the case of usage of FIG. 4, the access devices 20 and 80 transmit location information items specific to the technology of the access network. This can be the TAI information item if the device 20 is a device of the LTE network and the SSID information item if the device 80 is a device of a Wi-Fi network. The DNS server 210, when it receives the request comprising the location indication based on the information item issued by the device 80, in this instance the SSID, can deduce on the basis of the lookup table that the indication received in the request corresponds to the indication received in the request comprising the indication based on the information item received from the device 20, the TAI of the LTE network. This table can moreover also integrate for example an identifier of the user terminal or indeed a session identifier. In the example adopted, the server matches up the SSID information items and the corresponding information items of TAI type. Thus the DNS server 210 is able to select the same contents server, whether the terminal 10 is connected to the access device 20 or the access device 80. This table makes it possible furthermore to select contents servers as a function of the location indication of a single technology, for example the TAI. The table ensures the correspondence between the location indications specific to other technologies, for example Wi-Fi, and the technology indication used for the selection, the indication specific to the LTE network in the example. The other attraction of a lookup table of correspondence between location indications for a terminal is that of being connected to one and the same content server if it connects successively to two access networks in one and the same geographical zone, thereby advantageously making it possible to maintain the access contexts, to benefit from a cache already fed with the content in the course of delivery, and to maintain the state of application sessions. This therefore allows optimal use of CDN and Fog computing while roaming (when the user terminal changes access network) with a gain for the user in terms of latency and for the operator in the cost of the networks.

Steps E27 and E28 which follow are thereafter identical to steps E8 and E9 described previously, these steps consisting in the terminal 10 accessing the desired content hosted on a contents server 50-1 close to the terminal. In this embodiment, the contents server selected by the selection server 210 is the same upon connection of the terminal 10 to the access device 80 as when the terminal 10 is connected to the access device 20. In this embodiment, the terminal 10 has not moved sufficiently to justify a change of contents server and it is logical that the selected contents server 50-1 should remain the same when the terminal 10 changes connection.

Exchanges of information between the contents server 50-2, the local server 50-1 and the access devices 20 and 80 which are not reported in this figure, in particular which are related to access authorizations, allow the contents server 50-1 to accept the connection of the terminal 10, whose IP address was allocated upon its connection to the access device 80.

This invention thus makes it possible to select as close as possible to the users common contents servers for the various access networks to which a terminal is liable to connect in a given environment. It also makes it possible to preserve access to one and the same contents server when the terminal changes access network in the course of a session but without changing location, thus making it possible to preserve a context, related for example to the use of an application by the terminal. In another embodiment, HTTP messages could be transmitted during additional steps, in particular in the case where the DNS servers are not selection servers. These messages, in the same manner as is described in FIG. 3, would be an HTTP request message to the contents server, in this instance an HTTP server, to which the latter would respond through an HTTP redirection message in accordance with the messages of the requests E13 and E15 of FIG. 3. These HTTP servers can furthermore also interface with lookup tables of location indications as described for the case where the selection server is a DNS server.

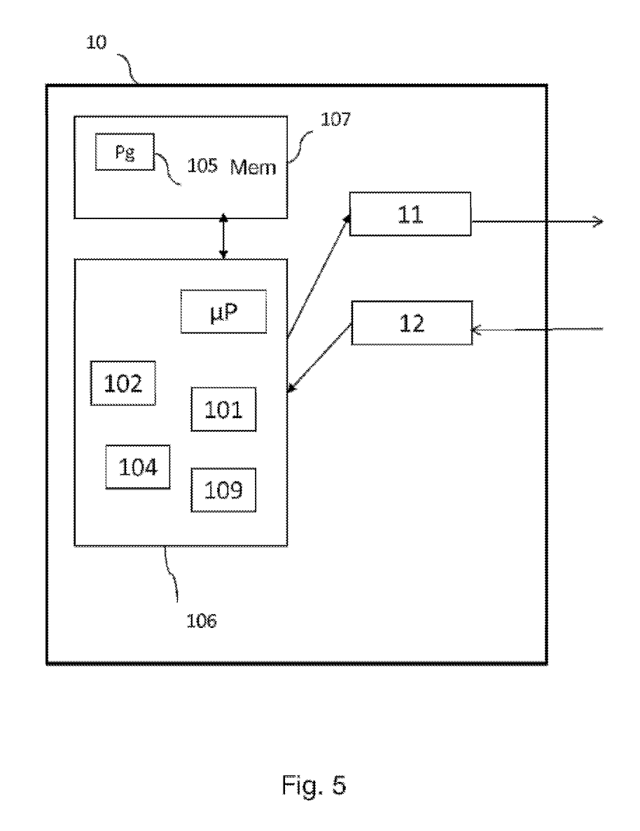

Reference is now made to FIG. 5 which illustrates the functions of a user terminal designed to accomplish the various steps of the method of content access according to a particular embodiment.

For example, the terminal 10 comprises a processing unit 106, equipped for example with a microprocessor μP, and driven by a computer program 105, stored in a memory 107. On initialization, the code instructions of the computer program 105 are for example loaded into a RAM memory, before being executed by the processor of the processing unit 106. The terminal comprises an interface 11 for issuing messages and an interface 12 for receiving messages.

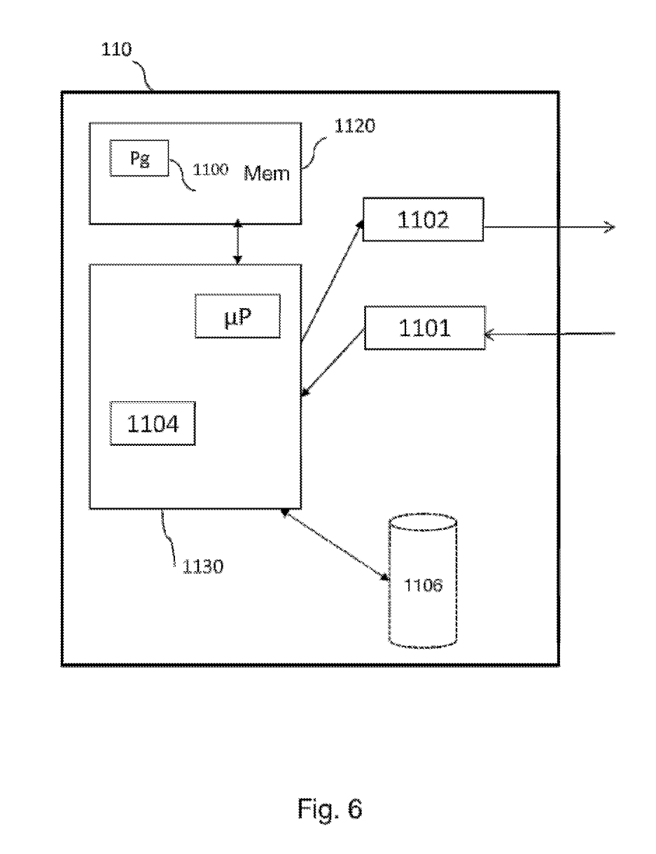

Such a user terminal furthermore comprises the following modules:
a module 101 able to process a received message originating from the access device comprising an information item relating to the location of said user terminal 10
a generator 104 of a request for access to a content comprising a location indication obtained on the basis of the information item extracted from the message
a module 102 able to process a message of issuing of the access request generated to a server 110 able to select a contents server 50-1
a module 109 able to process a message comprising an address of the selected contents server 50-1
   This user terminal might for example be a mobile terminal. This mobile terminal can connect a access networks of type 802.11, GPRS, UMTS (Universal Mobile Telecommunications Systems), HSPA (High Speed Packet Access), LTE or any other network based on a WLAN technology (Wireless Local Area Network) or cellular, and can access a content hosted on a server close to its location, thus reducing the time and the cost of access of this terminal to the content.
   Reference is now made to FIG. 6 which illustrates the functions of a selection server designed to accomplish the various steps of the method of selection according to a particular embodiment.

For example, the selection server comprises a processing unit 1130, equipped for example with a microprocessor μP, and driven by a computer program 1100, stored in a memory 1120. On initialization, the code instructions of the computer program 1100 are for example loaded into a RAM memory, before being executed by the processor of the processing unit 1130.

Such a selection server comprises the following modules:
a receiver 1101 of a message requesting access to a content originating from a user terminal 10 comprising an indication of location of said user terminal,
a selection module 1104 for selecting contents server 50-1 as a function of the location indication
an issuer 1102 of a message comprising an address of said contents server to the user terminal 10

Optionally, the selection server furthermore comprises a lookup table (1106) wherein are recorded inter alia location indications relating to at least two types of access networks.

A selection server might for example be a DNS server or an HTTP server, and will advantageously be able to implement the method of selection so as to return to the user terminal 10 the information item making it possible to reach a contents server—hosting the content requested by the user terminal—in proximity to the terminal of the user. The location indication can thus be used by the selection server as an additional criterion for selecting the contents server, in the case where the server already uses other criteria for selecting the contents servers, typically to distribute the load between servers.

The invention is not limited to the exemplary embodiments hereinabove described and represented and covers other embodiments.

The address of the server of contents which are returned to the terminal might be an IP address, of IPv4 or IPv6 type or it may entail any other means allowing the terminal to reach the contents server indicated in the response dispatched by the selection server, among which a URL, or indeed a type name for example FQDN (Fully Qualified Domain Name).

Furthermore, in the embodiments presented, the selection server is a DNS server or an HTTP server but it is also conceivable that the selection server is an FTP (File Transfer Protocol) server if the terminal opens an FTP connection to a contents server or any other type of server. In particular, in other modes of deployment, the selection server can be a specific server whose role is solely to select a contents server close to the user. In order to select a contents server close to the user, the selection server will advantageously be able to use a database with the help of which it will be able to identify the contents server which is suitable as a function of at least one location indication received from a terminal. This database will be able to integrate criteria other than the location indications to implement a contents server selection taking account of various criteria, among which the at least one location indication.

A database of the selection server, which database is designed to record contents servers and location indications received in the access request messages, can itself be shared between various selection servers so as to limit the number of databases and to enable the communications network selection servers to benefit from a single database or at least a limited number of databases. This database, in a manner in accordance with what is indicated in respect of the lookup table, can integrate location indications arising from various access networks, fixed and mobile, in such a way that the terminal independently of the access networks to which it is connected can benefit from a close contents server.

1. A method of access to a content located in a telecommunications network, implemented by a user terminal connected to a device of at least one access network of the telecommunications network, comprising the following steps:
receiving at least one message originating from the device, comprising an information item relating to the location of said user terminal,
generating a request for access to a content comprising a location indication obtained on the basis of the information item extracted from the message,
dispatching said access request generated to a server able to select a contents server,
receiving an address of the selected contents server.

2. The method of access as claimed in claim 1, where the request for access to a content is a request of HTTP type.

3. The method of access as claimed in claim 1, where the request for access to a content is a request of DNS type.

4. The method of access, as claimed in claim 1, where the access network is of cellular type and the information item relating to location is based on a parameter of “Tracking Area” type.

5. The method of access as claimed in claim 1, where the access network is of Wi-Fi type and the information item relating to location is based on an SSID parameter.

6. A method of selection implemented by a selection server comprising the following steps:
reception of a message requesting access to a content originating from a user terminal comprising an indication of location of said user terminal,
selection of a contents server as a function of the location indication,
dispatching of a message comprising an address of said contents server to the user terminal.

7. The method of selection as claimed in claim 6, furthermore comprising a step of consulting a lookup table of correspondence between location indications relating to at least two types of access networks.

8. A user terminal able to access a content located in a telecommunications network, connected to a device of at least one access network of the telecommunications network, the terminal comprising:
a processor; and
a non-transitory computer-readable medium comprising instructions stored thereon, which when executed by the processor configure the user terminal to perform acts comprising:
receiving and processing a message originating from the access device comprising an information item relating to the location of said user terminal,
generating a request for access to a content comprising a location indication obtained on the basis of the information item extracted from the message,
dispatching the access request generated to a server able to select a contents server,
receiving a message comprising an address of the selected contents server.

9. A selection server comprising:
a processor; and
a non-transitory computer-readable medium comprising instructions stored thereon, which when executed by the processor configure the selection server to perform acts comprising:
receiving a message requesting access to a content originating from a user terminal comprising an indication of location of said user terminal,
selecting a contents server as a function of the location indication,
dispatching a message comprising an address of said contents server to the user terminal.

10. The selection server as claimed in claim 10 furthermore comprising a lookup table of correspondence between location indications relating to at least two types of access networks.

11. A system for accessing a content comprising:
at least one terminal user terminal able to access a content located in a telecommunications network, connected to a device of at least one access network of the telecommunications network, the terminal comprising:
a first processor; and
a first non-transitory computer-readable medium comprising instructions stored thereon, which when executed by first the processor configure the user terminal to perform acts comprising:
receiving and processing a message originating from the access device comprising an information item relating to the location of said user terminal,
generating a request for access to a content comprising a location indication obtained on the basis of the information item extracted from the message,
dispatching the access request generated to a selection server able to select a contents server, and
receiving a message comprising an address of the selected contents server; and
the selection server, which comprises:
a second processor; and
a second non-transitory computer-readable medium comprising instructions stored thereon, which when executed by the second processor configure the selection server to perform acts comprising:
receiving the request for access to the content originating from the user terminal comprising the location indication of said user terminal,
selecting the contents server as a function of the location indication,
dispatching a message comprising an address of said contents server to the user terminal.

12. (canceled)

13. (canceled)

14. A non-transitory computer-readable recording medium on which code instructions of a computer program are stored, which when executed by a processor of a user terminal configure the user terminal to perform a method of access to a content located in a telecommunications network, the user terminal being connected to a device of at least one access network of the telecommunications network, wherein the method comprises:
receiving at least one message originating from the device, comprising an information item relating to the location of said user terminal,
generating a request for access to a content comprising a location indication obtained on the basis of the information item extracted from the message,
dispatching said access request generated to a server able to select a contents server,
receiving an address of the selected contents server.

15. A non-transitory computer-readable recording medium on which code instructions are stored, which when executed by a processor of a selection server configure the selection server to perform a method of selection comprising:
receiving a message requesting access to a content originating from a user terminal comprising an indication of location of said user terminal,
selecting a contents server as a function of the location indication,
dispatching a message comprising an address of said contents server to the user terminal.
